(19) United States
(12) Patent Application Publication
(10) Pub. No.: US 2014/0332660 A1
(43) Pub. Date: Nov. 13, 2014

(54) ORTHOGRAPHIC LENS SYSTEM

(71) Applicant: Brook Aaron Seaton, Oakland, CA (US)

(72) Inventor: Brook Aaron Seaton, Oakland, CA (US)

(21) Appl. No.: 13/892,339

(22) Filed: May 13, 2013

(51) Int. Cl. G01J 1/04; G02B 27/30

(52) U.S. Cl. CPC G01J 1/0411; G02B 27/30
USPC 250/200; 359/641

(57) ABSTRACT

A collimator for a detector, much like a 2D anti-scatter collimator of a computed tomography system, this system places a 2D collimator (1) between the object (2) and the detector (3). This system uses the 2D collimator in the place of a lens in a camera body, it is used to gather scattered photons (4), so the source (5) of the electromagnetic spectrum is not required to be placed in alignment with the 2D collimator.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

Example embodiments relate to 2D anti-scatter collimators (ASC) for x-rays and pinhole cameras.

2. Prior Art

The relevant information is found in the collimation of x-rays and pinhole cameras. In CT systems, scattered radiation reflecting off of dense materials gives rise to an additional signal during image reconstruction. However, said additional signal contribution results in a poorer signal-to-noise ratio so that disruptive image artifacts may arise if the proportion of scattered radiation changes locally, and distorts the image for the respectively adjacent detector.

The aim in using what is termed a 2D anti-scatter collimator (ASC) is to limit the detector's angular acceptance to the tube-focus direction and reduce the scattered radiation's contribution, so that the reconstructed images will, and in the end, have improved quality.

### SUMMARY

A collimator for a detector, much like a 2D anti-scatter collimator of a computed tomography system, this system places a 2D collimator between the object and the detector. This detector is used in the place of a camera lens, it gathers scattered photons, so the source of the electromagnetic spectrum is not required to be placed in alignment with the collimator and the detector.

### DRAWINGS

### Figures

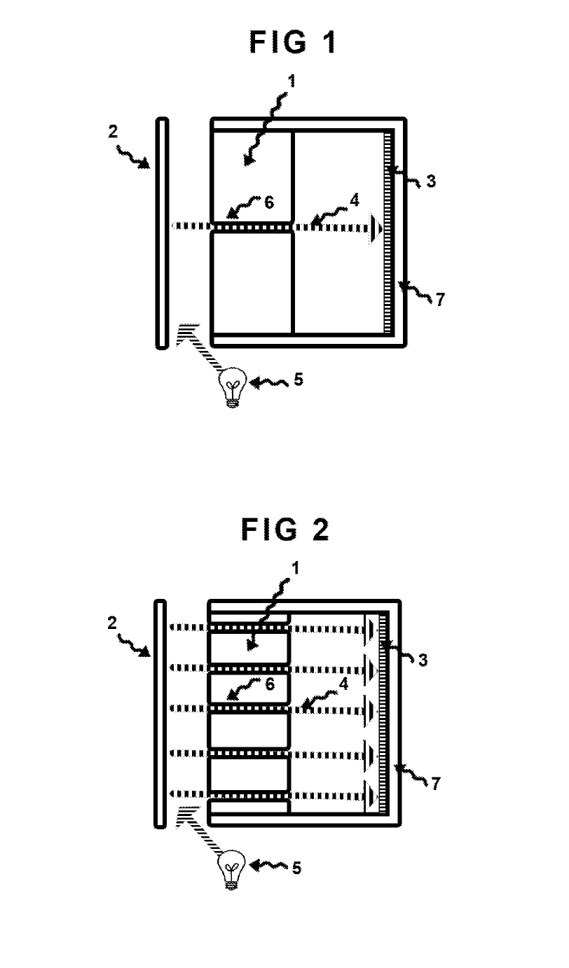

FIG. 1 demonstrates a camera which contains an individual thick-walled pinhole.

FIG. 2 demonstrates a camera which contains a 2D collimator composed of many thick-walled pinholes.

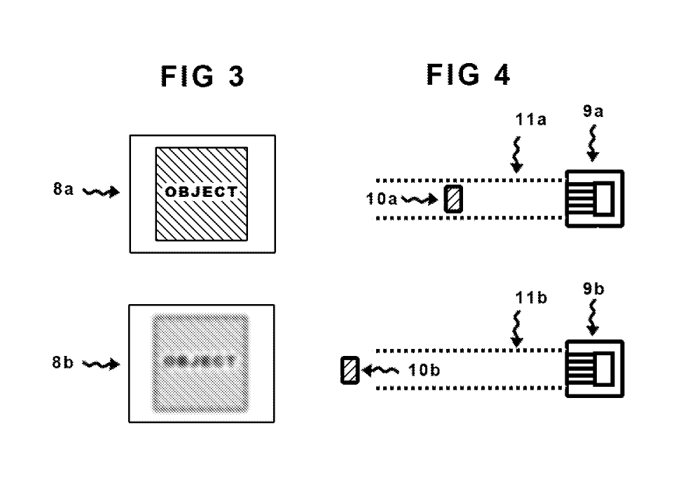

FIG. 3 shows the types of images produced by a camera which contains a 2D collimator.

FIG. 4 demonstrates the field of view of a camera which contains a 2D collimator.

### DETAILED DESCRIPTION

### FIGS. 1, 2, 3, 4

Various example embodiments will now be described more fully with reference to the accompanying drawings in which only some of the example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

FIG. 1 is a schematic representation of a cross section through a single thick-walled pinhole 6 and a detector 3 enclosed in a camera body 7. Positioned below the thick-walled pinhole is an example placement of a source of electromagnetic spectrum 5. Positioned to the left of the thick-walled pinhole is an example object 2 which scatters the electromagnetic spectrum. The thick-walled pinhole allows a narrow field of photons 4 to strike the detector. The two-dimensional collimator camera is not shown in its entirety, only as an individual thick-walled pinhole and a detector, an enclosing camera body is included in the schematic to demonstrate that the source of the electromagnetic spectrum must pass through the two-dimensional collimator to strike the detector. The entire two-dimensional collimator includes a plurality of thick-walled pinholes.

FIG. 2 is a schematic representation of a cross section through a two-dimensional collimator 6 and a detector 3 enclosed in a camera body 7. Positioned below the two-dimensional collimator is an example placement of a source of electromagnetic spectrum 5. Positioned to the left of the two-dimensional collimator is an example object 2 which scatters the electromagnetic spectrum 5. The thick-walled pinholes 6 each allow a narrow field of view 4 through the two-dimensional collimator 1, the fields expand as they approach detector. When the fields of view overlap, they will overexpose regions of the detector, so the fields are optimized when their overlap is minimized. The two-dimensional collimator is not shown in its entirety and not in the correct scale, as an accurate schematic contains a more abundant plurality of thick-walled pinholes which are placed in closer proximity.

FIG. 3 is an illustrated representation of photographs 8a and 8b produced by a two-dimensional collimator implemented in a camera system. Photograph 8a contains an image of a box with the word “OBJECT” inscribed on its front-facing surface, the image is in focus because the photographed box was placed near the outward-face of the two-dimensional collimator. Photograph 7b contains an image of the same box, but the image is out of focus because the photographed box was placed far from the outward-face of the two-dimensional collimator.

FIG. 4 is a schematic representation of a cross section through two-dimensional collimator cameras 9a and 9b. This figure demonstrates the placement of box 10a and 10b which will produce the photographs 8a and 8b, illustrated in FIG. 3. Box 10a is near the outward-face of the two-dimensional collimator, which will produce the in focus image 8a. Box 10b is far from the outward-face of the two-dimensional collimator, which will produce the out of focus image 8b. Parallel dotted lines 11a and 11b are the field of view of the 2D collimator's thick-walled pinholes. Unlike a pinhole camera, a two-dimensional collimator camera does not have an expanding field of view.

### Advantages

When a 2D collimator is placed between an object and a detector, the current state of the art embodies each 2D collimator as rows and columns of walls which reduce the amount of x-rays which are scattered by the object and arrive at the detector. The inventor recognized that when the source of the electromagnetic spectrum was not in alignment with the 2D collimator and detector, the photons scattered by the objects could pass through the collimator and gather on the detector to reconstruct an image.

Each collimator tube can be considered a thick-walled pinhole camera. A typical pinhole camera is contains with a thin wall and a single pinhole to allow a field of view through the aperture which arrives at the detector. As the pinhole camera's walls thicken, the pinhole becomes a tube and the radius of the field of view approaches the radius of the tube. With a field of view nearing the radius of the pinhole tube, many tubes can be placed closely in a 2D array such that a 2D collimator is formed which reduces or prevents the overlap of the field of views.

The inventor recognized that thick-walled pinholes, in aggregate, will produce an image of an object, so that a 2D collimator may function in the place of a lens for a camera. The rate of photons arriving at the detector through the 2D collimator is equivalent to that of a single pinhole camera. Unlike a pinhole camera, the maximum focused image is produced when the imaged object is placed at the face of the 2D collimator. As the object is moved away from 2D collimator's face, the object's size in the image does not scale, instead the object moves out of focus.

The inventor has recognized that 2D collimators are utilized as filters for unwanted x-ray image distortions and hence the material of the 2D collimator can be replaced with materials which absorb alternative ranges of the electromagnetic spectrum. An example material for the visible spectrum is carbon, but it lacks the strength properties to be formed into a 2D array. To achieve this purpose, carbon can gain structural strength when it is infused in a material which is translucent to the visible spectrum, such as para-methoxy-n-methylamphetamine (PMMA), silica, or other transparent material. Having the thick-walled pinholes filled with the same material as the infuser, the refractive index will not be altered at the surface between the thick-walled pinholes and the collimator, and thus avoid an increasing reflectivity at the surface.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A 2D collimator used in the place of a lens for a camera.

2. A 2D collimator as claimed in claim 1, wherein a source of the electromagnetic spectrum is not required to be placed in alignment with the 2D collimator's thick-walled pinholes.

3. A detector used to reconstruct an image gathered from scattered electromagnetic spectrum.

4. A detector as claimed in claim 3, which is placed at a distance such that the collimator as claimed in claim 1, minimizes the overlap from the 2D collimator's multiple fields of view.
